(19) United States
(12) Patent Application Publication
(10) Pub. No.: US 2004/0098244 A1
(43) Pub. Date: May 20, 2004

(54) Method and system for emulating tape storage format using a non-tape storage medium

(75) Inventors: Clark C. Dailey, Woodbury, MN (US); Yung Yip, Afton, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 10/294,514

(22) Filed: Nov. 14, 2002

(51) Int. Cl. G06F 9/455

(52) U.S. Cl. 703/24

(57) ABSTRACT

A system is described including a data tape cartridge carrying a non-tape storage medium, and a tape drive emulator that receives the data tape cartridge and stores data on the medium in a format that emulates a tape storage format. The tape drive emulator sequentially records the data within the logical storage areas of the non-tape storage medium, and maintains a library of tape marks on the storage medium to indicate locations within the stored data files. The library of tape marks may indicate, for example, file marks, sequential file marks, block marks, and other demarcations within the stored data. The tape drive emulator makes use of the library of tape marks to access the non-tape storage medium in response to tape access commands from a host computing devices.

### TECHNICAL FIELD

The invention relates to data storage devices.

### BACKGROUND

A conventional data tape cartridge consists of a tape, i.e., an elongated flexible medium having a magnetic recording layer, wound on one or more reels or hubs. Data is recorded and retrieved by inserting the data tape cartridge within a tape drive and passing the recording medium in front of one or more read/write heads. Tape drives are usually streaming devices in which data is recorded in serpentine fashion as the tape streams back and forth. In particular, the tape drive typically writes the data along a number of tracks that span the length of the medium. For this reason, tape drives can be viewed as sequentially writing the data in a “linear” format. Examples of various tape drives and recording media that utilize a linear format include quarter-inch cartridge drives with serpentine track layout and DLT (digital linear tape).

The tape drive typically receives the data from a host computing device as a sequential stream of records, also referred to as files. To allow the separation of different files on the tape, the host computing device separates the files in the data stream with special markers, referred to as end-of-file marks, or simply “file marks.” By convention, a single file mark may be used to signal the end of an individual file, while two file marks may signal the end of recorded data. Further, each file typically includes a number of data blocks. The host may, for example, issue a WRITE FILE MARK command, followed by one or more WRITE DATA commands and corresponding blocks of data.

The host computing device may use a variety of different types of tape marks depending on the drive mechanism, medium format, and the software used to write the tape, such as file marks, sequential file marks, block marks, end-of-data marks, and the like. Due to this linear data storage format, tape drives do not support true random access to individual files, but allow some limited positioning operations by utilizing the tape marks embedded within the data sequentially stored on the tape. For example, the drive may support such operations as rewinding or forwarding generally, such as moving across a given number of file marks, across a given number of block marks, or positioning the tape at the end of recorded data to append additional files.

### SUMMARY

In general, the invention is directed to techniques for emulating the linear tape storage format using a non-tape storage medium. In particular, in accordance with the techniques, data can be written to the non-tape storage medium in a sequential format that emulates the linear tape format, but provides random access to the stored data for high-speed access.

In one embodiment, a method comprises receiving data in accordance with a tape drive communication protocol, storing the data on a non-tape storage medium, and updating a library of tape marks on the non-tape storage medium to identify locations within the stored data.

In another embodiment, a system comprises a data tape cartridge containing a non-tape storage medium having a set of logical storage areas, and a tape drive emulator to receive the data tape cartridge and sequentially store data within the logical storage areas of the non-tape storage medium.

In another embodiment, a data tape cartridge comprising a non-tape storage medium, and format identification data stored by the non-tape storage medium that marks the non-tape storage medium as formatted to emulate linear tape storage.

In another embodiment, a non-tape storage medium having data comprising a header having format identification data that marks the non-tape storage medium as formatted to emulate linear tape storage, and a data region of sequentially stored data files. The non-tape storage medium further comprises a library of tape marks to indicate locations within the stored data in accordance with a tape drive communication protocol.

In another embodiment, a tape drive emulator comprises a controller to sequentially store data on a non-tape storage medium in accordance with a format that emulates a linear tape storage format, wherein the controller maintains a library of tape marks on the storage medium to indicate locations within the data in accordance with a tape drive communication protocol.

The invention may be capable of providing a number of advantages. The techniques and storage format described herein may allow a tape drive emulator to efficiently respond to commands received from a host computing device in accordance with a conventional tape storage protocol. Consequently, the techniques allow the non-tape storage medium to appear to the host computing device as a conventional sequential storage device. The techniques allow a non-tape storage medium to store data in a format that emulate linear tape storage, yet support high-speed, random access to the stored data.

In addition, by making use of the invention, an automated data tape cartridge system may include a number of conventional data tape cartridges housing magnetic tape, as well as a number of data tape cartridges housing non-tape media. Regardless of the type of internal storage media, the data tape cartridges may have housings conforming to standard dimensions and features to be easily manipulated by the automation system. In this manner, the mechanical interfaces between the automation systems need not be adapted or upgraded to support data tape cartridges having non-tape media. In other words, because the data tape cartridges conform to standard dimensions, data tape cartridges housing different types of media can be mechanically indistinguishable by the automation system. Accordingly, the automated data tape cartridge system may readily include tape drives for accessing conventional data tape cartridges, and tape drive emulators for accessing data tape cartridges having non-tape media.

Furthermore, the data tape cartridges housing non-tape storage media may be self-contained storage devices that include necessary electronics and control circuitry for accessing the storage media. For example, a data tape cartridge may have standard external dimensions and features of a data tape cartridge, but may house a disk drive including the disk-shaped storage medium as well as the disk drive controller and read/write circuitry.

In addition, the tape drive emulator receives a data tape cartridge carrying the non-tape storage medium and translates commands and performs other operations such that the data tape cartridge appears as a conventional sequential storage device to the host computing device. In this manner, the non-tape storage medium physically appears the same as a magnetic data tape cartridge from the perspective of the automation system, and functionally appears the same from the perspective of the host computing device.

The external electrical connector of the data tape cartridge and the socket of the tape drive provide a robust electrical connection between the tape drive emulator and the data tape cartridge. Accordingly, a wide variety of storage media may be used within a library automation system with little or no change to the automation unit or the host computing device, thereby expanding the capabilities of the tape library automation system.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example system in which a data tape cartridge stores data on a non-tape storage medium in a format that emulates the tape storage format.

FIG. 2 illustrates example data structures format used by a tape drive emulator to store data on non-tape storage medium in a manner that emulates the tape storage format used by a conventional tape drive.

FIG. 3 illustrates the allocation of logical storage areas as the tape drive emulator of FIG. 2 stores data files from a host computing device.

FIG. 4 illustrates an example data structure for a tape header as written by the tape drive emulator to the non-tape storage medium.

FIG. 5A illustrates an example data structure for a library of tape marks as written by the tape drive emulator.

FIG. 5B illustrates an example data structure for a tape mark sector.

FIG. 5C illustrates an example data structure of an individual tape mark locator for emulating a tape mark.

FIG. 5D illustrates an example embodiment of a tape mark library as stored on a non-tape storage medium.

FIG. 6 is a flowchart illustrating an example operation of the tape drive emulator.

FIG. 7 is a block diagram illustrating example embodiments of the tape drive emulator and the data tape cartridge having a non-tape storage medium.

FIG. 8 is a block diagram illustrating another example embodiment of a tape drive emulator and a data tape cartridge carrying a non-tape storage medium.

FIG. 9 is a block diagram illustrating another example embodiment of a data tape cartridge carrying a non-tape storage medium.

FIG. 10 is a block diagram illustrating an automated data tape cartridge library system.

### DETAILED DESCRIPTION

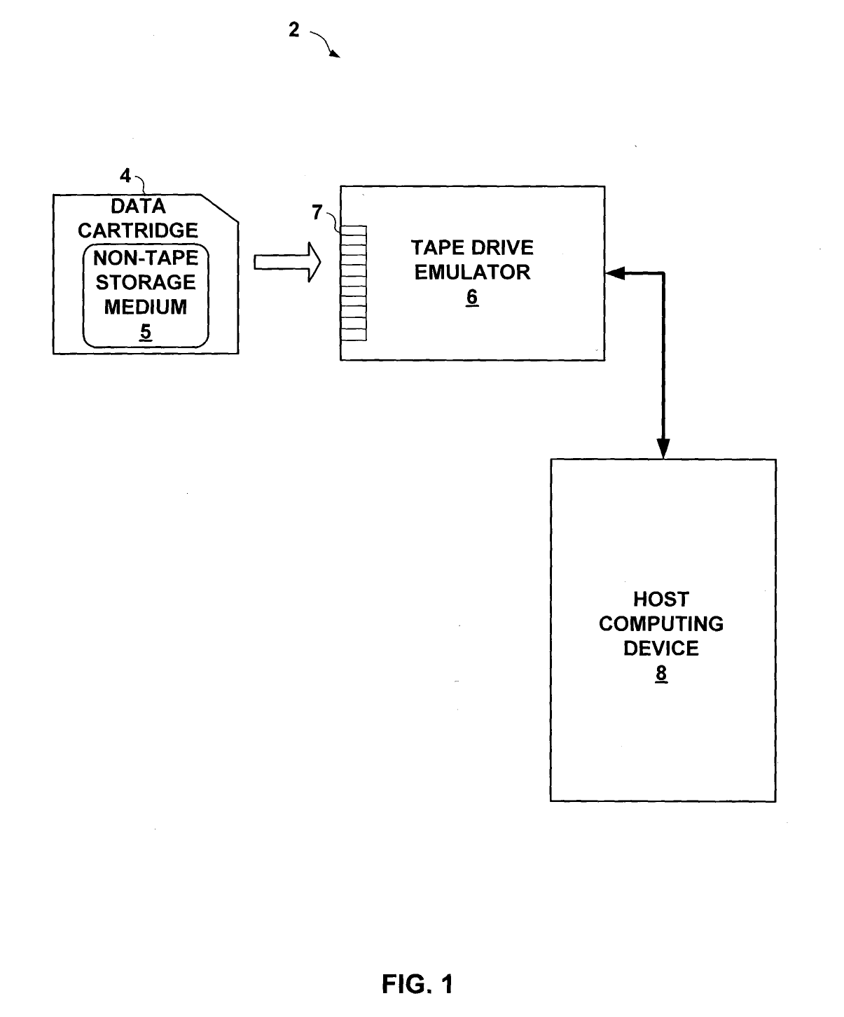

FIG. 1 is a block diagram illustrating a system 2 in which a data tape cartridge 4 stores data on a non-tape storage medium 5 in a format that emulates a tape storage format. Non-tape storage medium 5 may take the form of a variety of storage media, such as a disk-shaped magnetic storage medium, a solid-state storage medium, an optical storage medium, a magneto-optical storage medium, and a holographic storage medium.

Tape drive emulator 6 receives data tape cartridge 4, and provides access to non-tape storage medium 5 as a conventional tape drive. In other words, tape drive emulator 6 communicates with host computing device 8 in accordance with a tape storage protocol, thereby allowing non-tape storage medium 5 to appear to host computing device 8 as a conventional sequential storage device. For example, in response to a query from host computing device 8, tape drive emulator 4 may identify itself as a conventional tape drive, such as a standard 3480 tape drive. Consequently, the drivers and other software applications that may reside on host computing device 8 for accessing conventional tape-based data tape cartridges need not be modified to access non-tape storage medium 5 within data tape cartridge 4. Tape drive emulator 6 and host computing device 8 may communicate in accordance with a conventional protocol used by tape backup systems, such as Small Computer System Interface (SCSI), or other protocol.

To efficiently respond to access commands received from host computing device 8, tape drive emulator 6 translates the sequential data structures typically used for a tape storage medium into a format useable for non-tape storage medium 5. For a disk-shaped storage medium, for example, tape drive emulator translates the sequential data structures typically associated with a tape storage medium into a format compatible with the cylinder and head format typically used by a disk drive.

As described in detail below, tape drive emulator 6 may make use of a logical storage space presented by non-tape storage medium 5. The logical storage space may comprise a plurality of sequentially numbered logical storage areas. Conventional disks, for example, may be formatted to present a plurality of Logical Block Addresses (LBAs), which are mapped to the underlying physical storage areas. A single LBA may, for example, comprise a 512-byte physical storage sector on non-tape storage medium 5.

Tape drive emulator 6 receives commands and data from host computing device 8. For example, tape drive emulator 6 may receive data access commands, positioning commands, and the like. For example, host computing device 8 may issue one or more WRITE FILE MARK commands, followed by one or more WRITE DATA commands. Each WRITE DATA command is typically followed by a block of data. As another example, host computing device 8 may issue a positioning command and specify a relative number of tape marks, e.g., a command may instruct the emulator 6 to rewind the tape by N data blocks. Host computing device 8 may use a variety of different types of tape marks depending on the drive mechanism, medium format, and the software used to write the data to tape drive emulator 6. Accordingly, examples of tape marks that may be used by host computing device 8 within the data stream include file marks, sequential file marks, block marks, end-of-data marks, and the like.

Tape drive emulator 6 writes the data sequentially within the logical storage areas of non-tape storage medium 5. Tape drive emulator 6 may, for example, receive data blocks of size M, and sequentially assign the M data bytes of each block to M/N logical storage areas, where N equals the number of bytes within a logical storage area. Alternatively, tape drive emulator 6 may compress the received data blocks, and sequentially write the compressed data to the logical storage areas.

These approaches may be advantageous in that non-tape storage medium 5 may comprise a self-contained disk drive embedded within data tape cartridge 4 that may manage the mapping of logical block addresses to physical block addresses. Consequently, tape drive emulator 6 need only manage the quantity and locations of the logical storage space used to store the data in the format for efficient emulation of a tape storage medium.

While writing the data within the logical storage areas of non-tape storage medium, tape drive emulator 6 maintains a library of tape marks based on the tape marks embedded within the data received from host computing device 8. Specifically, tape drive emulator 6 maintains the library of tape marks to emulate the tape marks used by host computing device 8 as if communicating with a conventional tape drive. For example, upon receiving a WRITE FILE MARK command, tape drive emulator 6 records a new file mark within the library, as described in detail below. Upon receiving a WRITE DATA command, tape drive emulator 6 records a block mark within the library, and sequentially writes the data to non-tape storage medium 5.

The library associates the recorded tape mark with a position or offset within the data. Consequently, tape drive emulator 6 may use the tape mark library to indicate locations of the files, data blocks, end of data, and the like, and may readily respond to positioning commands from host computing device 8 that make use of the tape marks.

Tape drive emulator 6 may write the library to a designated area of the logical storage areas within non-tape storage medium 5, and may cache the library for efficient access. Due to the random access nature of non-tape storage medium 5, tape drive emulator 6 need not write the tape marks between each stored data file, as is typically done with conventional tape drives. To access a specific data file, tape drive emulator 6 need only access the library of tape marks to identify a target file mark associated with the data file, and map the target file mark to a starting one of the logical storage areas for immediate access to the stored data.

These techniques may advantageously allow tape drive emulator 6 to respond to a variety of tape access commands received from host computing device 8, including those commands that specify tape marks. For example, tape drive emulator 6 may receive a command to advance or rewind a tape a specified number of file marks. In response, tape drive emulator 6 need only access the library of tape marks to identify a target tape file mark.

In addition, tape drive emulator 6 may maintain a header within non-tape storage medium 5 that includes a variety of information relating to the emulation format. The header may include, for example, format identification data that marks the non-tape storage medium as emulating linear tape storage format. In this manner, tape drive emulator 6 may readily distinguish between data tape cartridges having non-tape storage media of different emulation formats. In addition, the header may include a directory that identifies logical storage areas for a beginning of recorded data, a current end of recorded data, an end of available storage space, a beginning of the library of tape marks, and an end of the library of tape marks. The header may specify other relevant information for non-tape storage medium 5, such as a type and capacity of the non-tape storage medium. The header may, for example, be stored at logical block area zero within non-tape storage medium 5.

Tape drive emulator 6 includes a socket 7 for receiving data tape cartridge 4. As illustrated below, socket 7 provides an electrical interface for accessing the non-tape storage medium contained with data tape cartridge 4. In particular, data tape cartridge 4 may house a fully self-contained, non-tape storage device, including all necessary electronics and control circuitry for accessing the non-tape storage medium. For example, data tape cartridge 4 may house a disk drive including a disk-shaped storage medium as well as a disk drive controller, actuator, magnetic transducer, pre-amplifiers and read/write circuitry.

Data tape cartridge 4 may include a housing that conforms to standard external dimensions and features of magnetic data tape cartridges. For example, the external dimensions of data tape cartridge 4 may conform to one of a number of industry-standard form factors, such as the form factors of the Black Watch™ 9840 and Royal Guard™ 3480, 3490E, 3490EL and 9490EE magnetic storage tape cartridges manufactured by Imation Corp. of Oakdale, Minn.

Tape drive emulator 6 may have a form factor of a standard tape drive such that the location of socket 7 conforms to the location of a slot within the standard tape drive. In this manner, automation equipment within a data tape cartridge library system, as described below, may readily insert and remove data tape cartridge 4 without requiring modification to tape drive emulator 6 or the automation equipment.

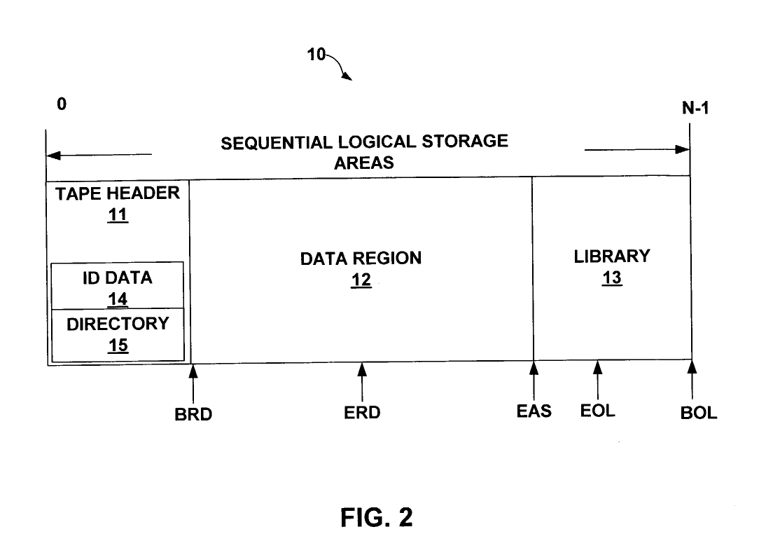

FIG. 2 illustrates example data structures format 10 used by tape drive emulator 6 to store data on non-tape storage medium 5 in a manner that emulates the tape storage format used by conventional tape drives. As illustrated, format 10 occupies N logical storage areas available within non-tape storage medium 5, and includes a tape header 11, a data region 12, and a library of tape marks 13. In other words, each of tape header 11, data region 12, and library 13 occupy corresponding logical storage areas.

Tape drive emulator 6 receives data from host computing device 8, and writes the data sequentially within data region 12. As described above, tape drive emulator 6 may receive write commands for one or more data blocks. Tape drive emulator 6 sequentially assigns logical storage areas within data region 12 to store the data. In response to commands from host computing device 8, tape drive emulator 6 sequentially writes the data to the logical storage areas of data region 12, and maintains library 13 of tape marks to record tape marks, such as file marks, sequential file marks, block marks, and the like.

Tape header 11 includes a variety of information that describes emulation format 10 and, in particular, the allocation of tape header 11, data region 12, and library 13 within the N logical storage areas of non-tape storage medium 5. As illustrated, tape header 11 is stored within the first logical storage area, i.e., logical storage area zero. Tape header 11 includes format identification data (ID DATA) 14 that identifies a particular emulation format used to store data on non-tape storage medium. In this manner, tape drive emulator 6 may readily distinguish between data tape cartridges having non-tape storage media of different emulation formats.

In addition, tape header 11 includes a directory 15 that includes data specifying the current allocation of logical storage areas for format 10. Specifically, directory 15 stores a number of pointers including a beginning of recorded data (BRD), a current end of recorded data (ERD), an end of available storage space (EAS), a beginning of the library of tape marks (BOL), and a current end of recorded file marks within the library (EOL). In this manner, directory 15 may be viewed as a table of contents for format 10. Tape header 11 may specify other relevant information for non-tape storage medium 5, such as a type and capacity of the non-tape storage medium.

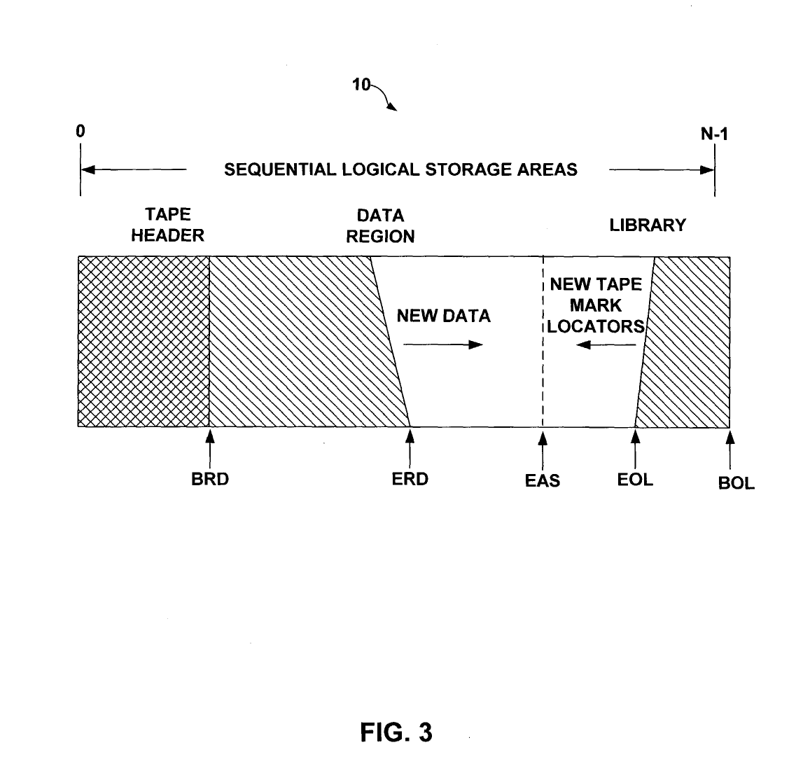

FIG. 3 provides another view of format 10 and, in particular, illustrates the allocation of logical storage areas as tape drive emulator 6 stores data from host computing device 8. In the illustrated example, tape drive emulator 6 sequentially writes the data within data region 12 in increasing logical storage areas. Specifically, tape drive emulator 6 accesses tape header 11 to determine a logical storage area associated with the current end of recorded data (ERD) within data region 12, and assigns a received block of data to the next higher logical storage area.

In addition, tape drive emulator 6 may maintain library 13 in reverse order. Specifically, tape drive emulator 6 sequentially stores tape mark locators in decreasing logical storage areas, and decreases the current end of recorded file marks (EOL) to reflect the expansion of library 13. This technique may be advantageous in that library 13 cannot become “full” until the non-tape storage medium 5 is completely used, i.e., when ERD and EOL converge.

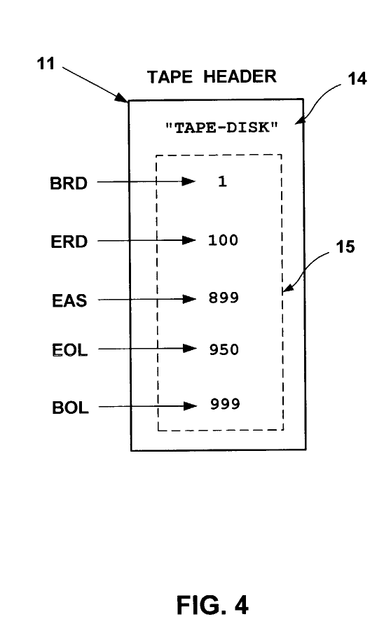

FIG. 4 illustrates an example data structure for tape header 11 as written by tape drive emulator 6. In the illustrated example, tape header 11 includes format identification data (ID DATA) 14 of “TAPE-DISK” written within the first nine bytes of the header. Tape drive emulator 6 may use this data, for example, to determine that data tape cartridge 4 (FIG. 1) contains a disk-based, non-tape storage medium that has been formatted for tape emulation.

In addition, the example tape header 11 of FIG. 4 includes directory 15 allocated within the next 10 bytes, assuming each pointer of the directory is a 32-bit pointer that occupies four bytes. The size of the pointers may be changed depending on the capacity of non-tape storage medium 5.

In the example, directory 15 identifies a beginning of recorded data (BRD) at logical storage area 1. The first logical storage area is allocated for storing tape header 11. Directory 15 further identifies a current end of recorded data NERD) at logical storage area 100, an end of available storage space (EAS) at logical storage area 899. Accordingly, data region 12 occupies logical storage areas 1-899, with areas 100-899 available for storing data files. Directory 15 also identifies a beginning of the library of tape marks (BOL) at logical storage area 999, and a current end of recorded file marks within the library (EOL) at logical storage area 950. In other words, in this example, tape drive emulator 6 has written tape marks to library 13 in descending order from logical storage area 999 to logical storage area 950.

Tape header 11 may include other data structures, such as a count of the number of tape mark locators written to library 13. In addition, tape header 11 may include allocated space for pointers to bad sectors within the logical storage area of the data region.

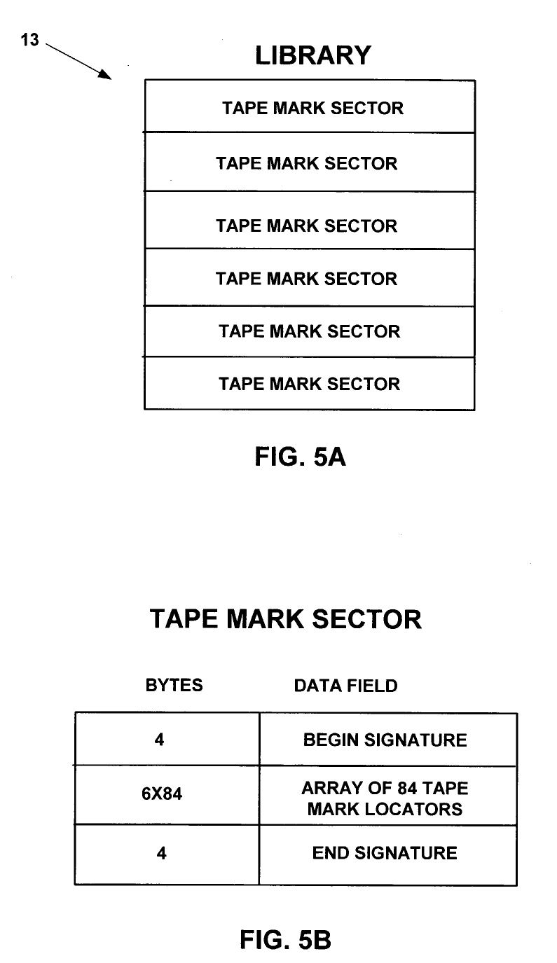

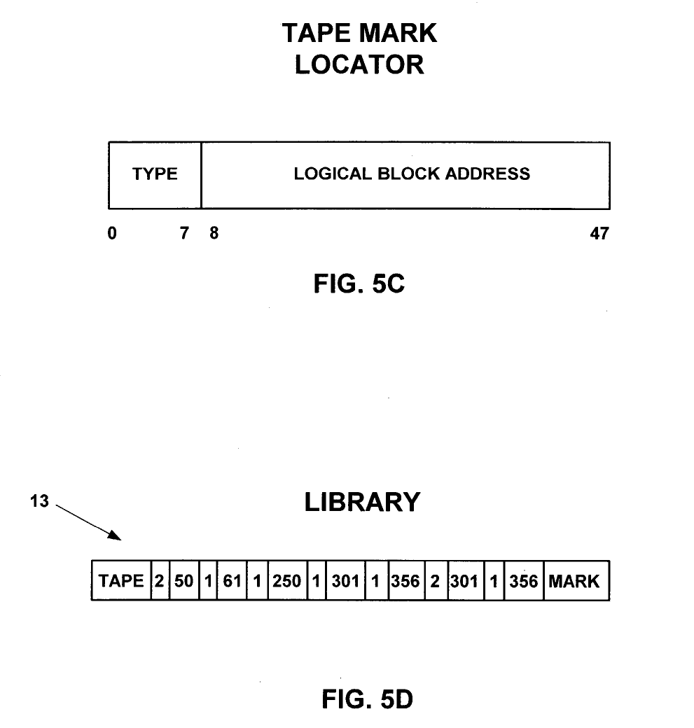

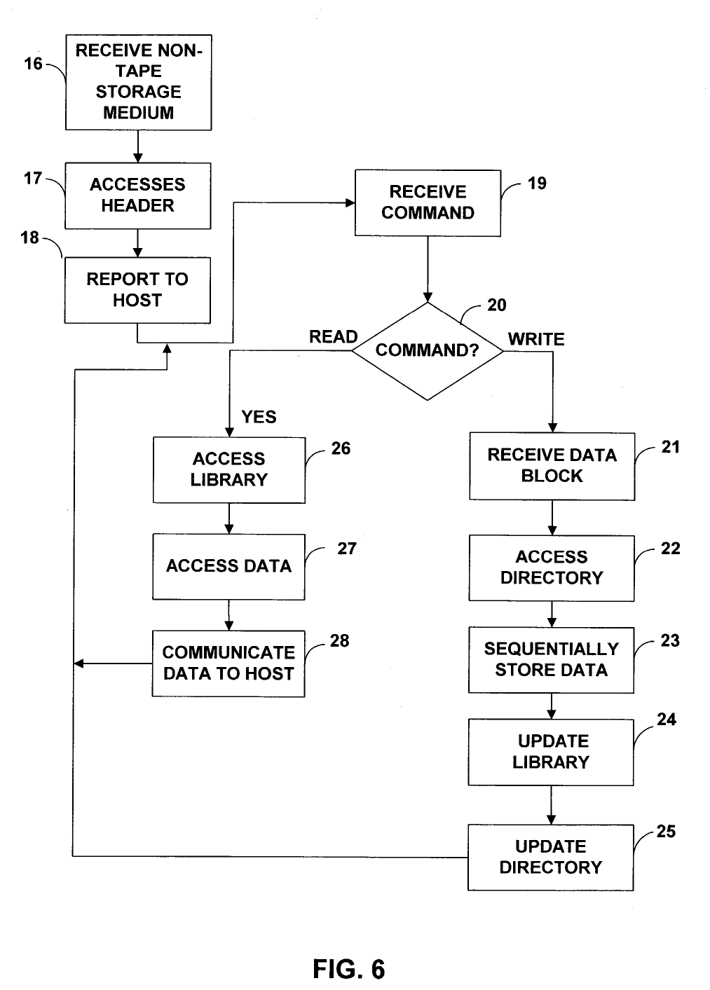

FIG. 5A illustrates an example data structure for library 13 as written by tape drive emulator 6. As illustrated, a tape drive emulator 6 writes the library as a dynamic array of one or more tape mark sectors. Tape drive emulator allocates new tape mark sectors as needed to store tape mark locators for emulating the tape marks, e.g., file marks, block marks, sequential file marks, that are embedded within the data stream received from host computing device 8. As described above, tape drive emulator 6 allocates tape mark sectors in decreasing logical storage areas to maximize the data region of non-tape storage medium 5.

FIG. 5B illustrates an example data structure for a tape mark sector. In the illustrated data structure, the tape mark sector includes three data fields. The first data field stores a signature to indicate the start of the tape mark sector, such as the four-byte string “TAPE.” Similarly, the third data field stores a signature to indicate the end of the tape mark sector, such as the four-byte string “MARK.”

The second field consists of an array of tape mark locators for emulating tape marks. In this example, the array stores eight-four (84) tape mark locators that consume six bytes each. Consequently, each tape mark sector consumes 512 bytes of logical storage.

FIG. 5C illustrates an example data structure of an individual tape mark locator for emulating a tape mark, such as a block mark, a file mark, and sequential file mark, and other conventional tape marks used in communicating with tape drives. As illustrated, a tape mark locator may comprise forty-eight bits split into two data fields, (1) a tape mark type, and (2) an associated logical block address for the emulated tape mark.

The tape mark type data field consists of eight bits that indicate the type of tape mark being emulated, as illustrated in the following exemplary table.

TABLE 1

| VALUE | TAPE MARK TYPE |
|---|---|
| 0 | NONE |
| 1 | BLOCK MARK |
| 2 | FILE MARK |
| 3 | SEQUENTIAL FILE MARK |
| 4-255 | RESERVED FOR OTHER TYPES |

The second data field consists of forty bits that associates the emulated tape mark with a logical storage area within the data region, i.e., a position within the sequentially stored data. By accessing library 13 and reading the associated logical block addresses for the emulated tape marks, tape drive emulator 6 is able to support conventional tape drive positioning commands, such as moving across a given number of file marks, across a given number of block marks, or positioning the tape at the end of recorded data to append additional files.

FIG. 5D illustrates an example embodiment of library 13. In the illustrated example, library 13 comprises a single tape mark sector starting with the signature “TAPE” and ending with the signature “MARK.” Between the signatures, library 13 includes seven tape mark locators that emulate seven tape marks.

The first tape mark locator indicates emulation of a tape mark of type “2,” i.e., a tape file mark, associated with a logical block address of 50. The next four tape mark locators emulate tape marks of type “1,” i.e., block marks, and are associated with logical block addresses of 61, 250, 301, and 356. In other words, the file mark and the four block marks may indicate that a data file is sequentially stored from logical address 50 to logical address 355. Similarly, a second data file starts at logical block 357, as indicated by the sixth tape mark locator.

FIG. 6 is a flowchart illustrating an example operation of tape drive emulator 6. Initially, tape drive emulator 6 receives data tape cartridge 4 carrying non-tape storage medium 5 (16), and accesses header 11 to determine various characteristics of the data tape cartridge (17). For example, tape drive emulator 6 may determine whether format identification data 14 is present within non-tape storage medium 5, i.e., whether data tape cartridge 4 carries a non-tape storage medium formatted for tape emulation, as described herein. In addition, tape drive emulator 6 may determine a capacity, a total available storage space, and other similar parameters for the non-tape storage medium 5. Tape drive emulator 6 reports the parameters to host computing device 8 as if medium 5 were a tape storage medium, i.e., using a tape storage communication protocol (18). For example, tape drive emulator 6 and host computing device 8 may communicate in accordance with a conventional protocol used by tape backup systems, such as Small Computer System Interface (SCSI), or other protocol.

Next, tape drive emulator 6 receives access commands from host computing device 8 in accordance with the tape drive communication protocol (19). Tape drive emulator 6 may receive a variety of commands, such as positioning commands, data access commands, and other commands supported by the tape drive communications protocol. For purposes of example, FIG. 6 illustrates the processing of a READ command or WRITE DATA command.

Tape drive emulator 6 may receive a WRITE DATA command from host computing device 8 followed by a block of data in accordance with a tape drive communication protocol (20,21). In response, tape drive emulator 6 accesses header 11 to retrieve end of recorded data (ERD) (22), and sequentially stores the data on non-tape storage medium 5 in the next available logical storage areas of data region 12 (23). In addition, tape drive emulator 6 updates the library of tape marks 13 on non-tape storage medium by allocating a new tape mark, and setting the type field to block mark (24). Further, tape drive emulator 6 updates directory 15 of header 11 to reflect the new ERD of data region 12 and EOL of library 13 (25).

If tape drive emulator 6 receives a READ command (20), the emulator accesses the library of tape marks to retrieve a target tape mark, such as a target file mark or a target block mark (26). For example, the access command may specify the READ request in relation to tape marks, e.g., a command to retrieve a number of sequential data blocks or files. Next, tape drive emulator 6 accesses the data within data region 12 based on the target tape mark (27), and communicates the accessed data files to host computing device 8 as a stream of data in accordance with a tape drive communication protocol (28).

As noted above, tape drive emulator 6 may receive a variety of other commands in addition to READ and WRITE DATA commands. Some of the commands, for example, may also require tape drive emulator 6 to update the library of tape marks. As one example of another command, tape drive emulator 6 may receive a WRITE FILE MARK command from host computing device 8. In response, tape drive emulator 6 allocates one or more tape mark locators within library 13, associates the tape mark locators with the current ERD, and sets the tape mark type to either FILE MARK or SEQUENTIAL FILE MARK depending on the particular command received. Similarly, other commands from host computing device 8 may result in the creation of other types of tape marks within library 13.

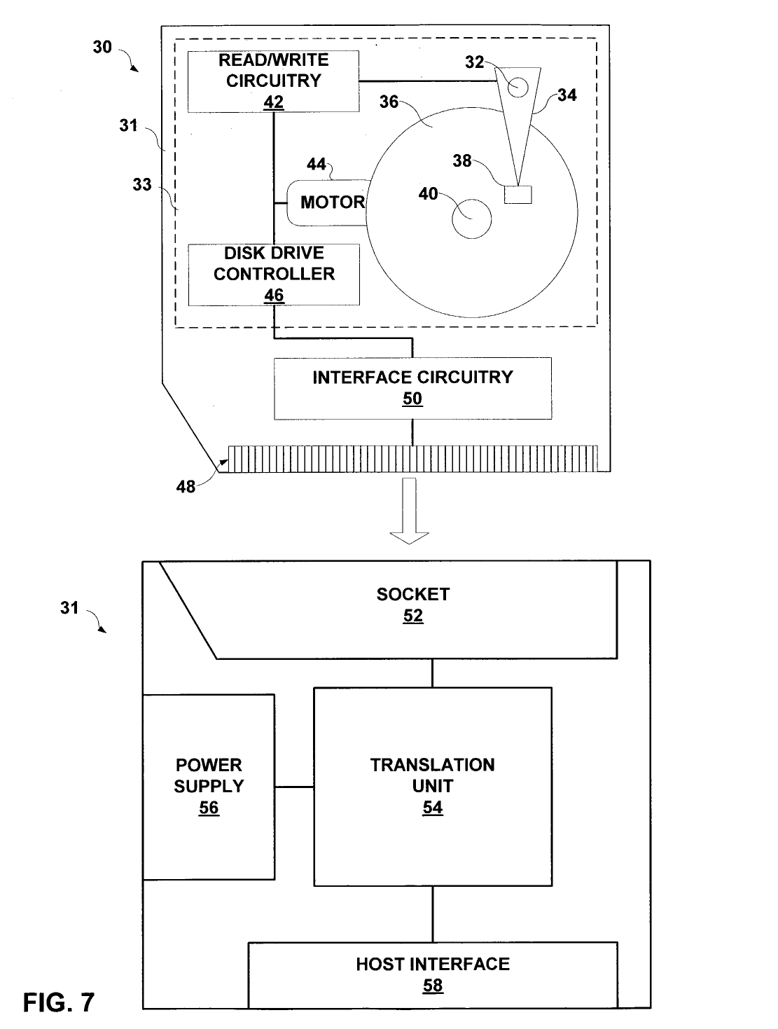

FIG. 7 is a block diagram illustrating example embodiments of a tape drive emulator 31 and a data tape cartridge 30 having a non-tape storage medium. Specifically, cartridge 30 includes a housing 31 that forms an enclosure for disk storage medium 36 and various other components. Disk storage medium 36 may be any disk-shaped storage medium such as magnetic, optic, magneto-optic and the like. In addition, disk storage medium 36 may be a hard disk or flexible disk. Spindle motor 44 rotates magnetic storage medium 36 around spindle hub 40. Actuator 34 rotates around actuator shaft 32, causing transducer 38 to traverse the rotating magnetic storage medium 36 for reading and writing data.

Disk drive controller 46 controls read/write circuitry 42 and actuator 34 to output signals to, and senses signals from, transducer 38. Disk drive controller 46 communicates with emulator 31 via interface 50. Interface 50 may implement a non-conventional communications protocol, or may implement any standard interface protocol, such as the Small Computer System Interface (SCSI), the Fibre Channel interface, the Enhanced Integrated Drive Electronics/AT Attachment (EIDE/ATA) interface, Serial ATA, or the like. In this manner, data tape cartridge 30 may comprise a fully self-contained disk drive 33, as may be purchased as an off-the-shelf component from one of a number of disk drive manufacturers, such as Seagate Technology of Scotts Valley, Calif.

Electrical connector 48 provides an externally available electrical interface for coupling to tape drive emulator 31 upon insertion. In particular, electrical connector 48 provides input/output electrical pins for communicating with, and receiving power from, tape drive emulator 31.

Tape drive emulator 31 includes socket 52 to make a robust electrical connection to electrical connector 48 of data tape cartridge 30 upon insertion. In one embodiment, socket 52 may comprise a zero insertion force (ZIF) socket. In particular, socket 52 may include a set of connectors operable to clamp and release electrical connector 48. Tape drive emulator 31 may, for example, mechanically actuate the connectors of socket 52 in response to sensing the insertion of the electrical connector of the data tape cartridge. Alternatively, gripper 86 may actuate a lever or other mechanical actuator of socket 52 to clamp down on and release the data tape cartridge 30. The layout of the mechanical connectors of socket 52 and the pins of connector 48 may take any one of a number of forms, such as array-shaped, staggered or inline.

Host interface 58 provides an electrical interface between tape drive emulator 22 and host computing device 8. Host interface 58 may conform to any one of a number of standard communication interfaces such as the Small Computer System Interface (SCSI), the Fiber Channel interface, the Network Data Management Protocol (NDMP), the Enhanced Integrated Drive Electronics/AT Attachment (EIDE/ATA) interface, or the like.

Tape drive emulator 31 may include a translation unit 54 for translating commands received from host interface 58 prior to delivering the commands to data tape cartridge 30 via socket 52. For example, translation unit 54 may receive commands from host interface 58 that are typical for sequential access devices, such as tape drives, and may translate the commands into commands that are more typical for disk drives or other storage devices. Translation unit 54 stores the data in logical storage areas managed by disk drive controller 46 and in accordance with format 10, as described above. In addition, translation unit 54 may provide data buffering, compression and decompression, data reformatting, error detection and correction, and the like, in order to provide a tape drive interface to host computing device 8 and a non-tape interface to the data tape cartridge 30. In this manner, tape drive emulator 31 allows a data tape cartridge carrying a non-tape storage medium to appear to host computing device 8 as a sequential storage device.

Furthermore, translation unit 54 allows host interface 58 and electrical connector 48 of data tape cartridge 30 to conform to different interface specifications. For example, translation unit 54 may support a SCSI interface between tape drive emulator 31 and host computer device 4, and an EIDE interface between tape drive emulator 31 and data tape cartridge 30. Translation unit 54 may comprise one or more custom application-specific integrated circuits. Alternatively, translation unit 54 could be implemented as a single board computer.

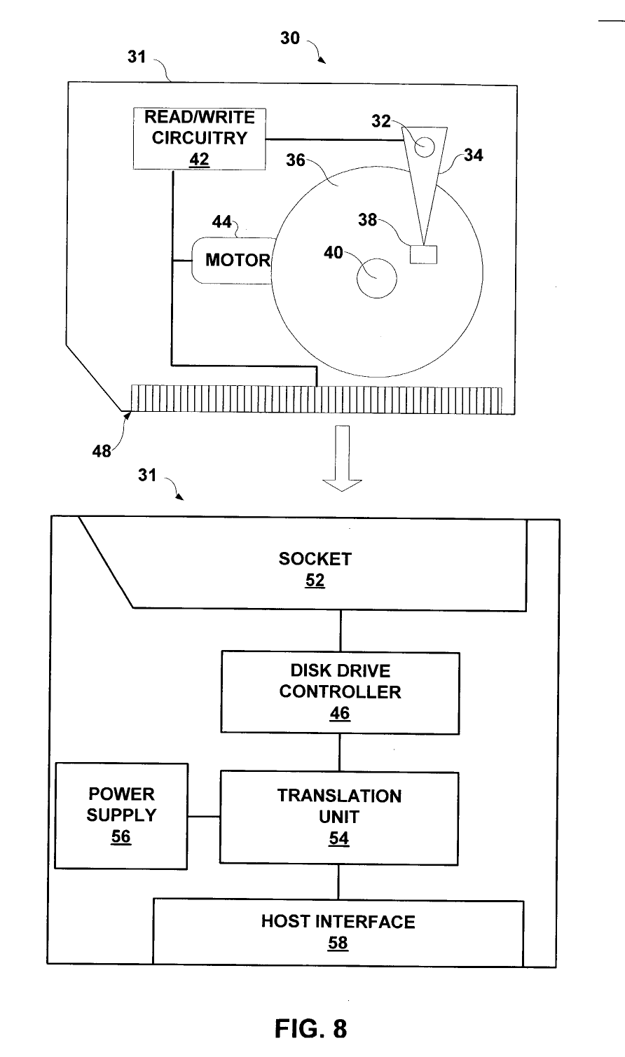

FIG. 8 is a block diagram illustrating another example embodiment of tape drive emulator 31 and data tape cartridge 30. In the illustrated embodiment, tape drive emulator 31 includes a portion of the drive electronics for accessing disk storage medium 36. Tape drive emulator 31 may include, for example, disk drive controller 46. As a result, data tape cartridge 30 may not need to include interface circuitry 50. In this manner, the cost and weight of data tape cartridge 31 may be reduced, which may be advantageous for high-volume applications. However, data tape cartridge 30 may no longer house a self-contained disk drive that can be purchased “off-the-shelf.” In either case, electrical connector and socket 52 provide a robust electrical connection between tape drive emulator 31 and data tape cartridge 30 upon insertion.

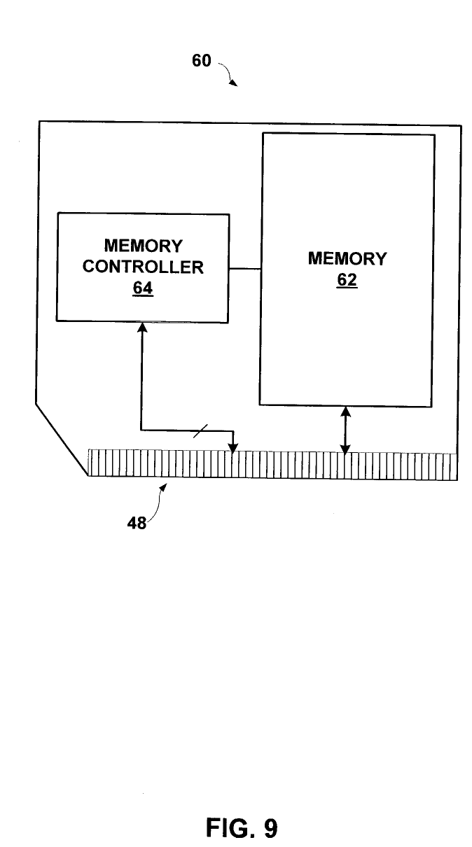

FIG. 9 is a block diagram illustrating another example embodiment of a data tape cartridge carrying a non-tape storage medium. Specifically, data tape cartridge 60 includes a solid-state memory 62 and a memory controller 64. Solid-state memory 62 may be any non-volatile memory such as an electrically erasable programmable read only memory (EEPROM), an electrically programmable memory (FLASH memory), or the like. Memory controller 64 receives access requests from tape drive emulator 31 and performs address calculations to access storage locations within solid-state memory 62.

In this embodiment, translation unit 54 (FIG. 3) translates commands received from host interface 58 prior to delivering the commands to data tape cartridge 30 via socket 52. In particular, translation unit 54 translates the commands from host interface 58 that are typical for tape drives into commands suitable for accessing one or more addressable storage cells within memory 62. In addition, translation unit 54 stores the data in the addressable storage cells in accordance with format 10, as described above. In this manner, tape drive emulator 31 allows data tape cartridge 60 housing a solid-state storage medium to appear to host computing device 8 as a sequential storage device.

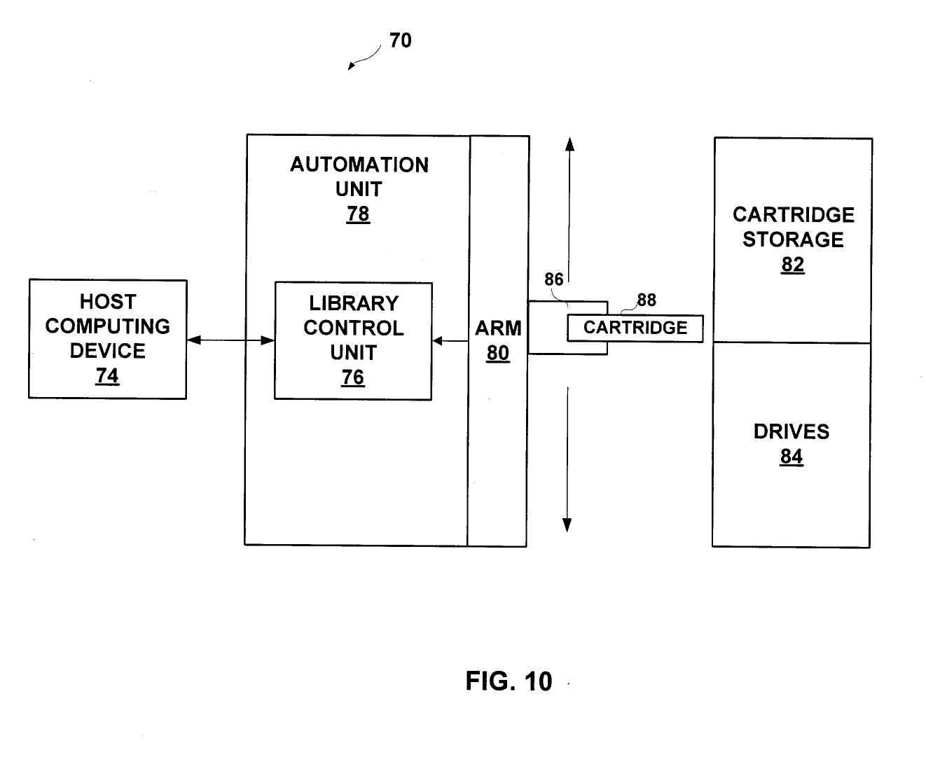

FIG. 10 is a block diagram illustrating an automated data tape cartridge library system 70 in which one or more data tape cartridges store data on a non-tape storage medium in a format that emulates the tape storage format. More specifically, automation unit 78 selectively retrieves data tape cartridge 88 and loads the retrieved data tape cartridge 88 into one of drives 84. When the drive is finished with the data tape cartridge 88, automation unit 78 retrieves the data tape cartridge 88 from the drive and returns it to the assigned storage location within cartridge storage 82.

Accordingly, cartridge storage 82 provides a plurality of data tape cartridge storage locations. Each location, also referred to as a cell, provides storage for a single data tape cartridge. Each data tape cartridge typically includes a housing having standard dimensions and features to be easily engaged by automation unit 78. In addition, the data tape cartridges may have some type of identifying information, such as a label, a bar code, or a radio frequency (RF) tag, by which the automation unit 78 identifies the individual data tape cartridges.

Host computing device 74 communicates with library control unit 76 to direct operation of data tape cartridge library system 70. In response to an access request from host computing device 74, library control unit 76 generates control signals to direct a robot arm 10 to retrieve the appropriate data tape cartridge from cartridge storage 82 and insert the data tape cartridge into one of drives 84. In particular, library control unit 76 interprets storage access requests from host computing device 74, and provides signals to control the motion and operation of robotic arm 80 and a gripper 86. In response to the signals, robotic arm 80 traverses cartridge storage 82 and engages a cartridge 18 using gripper 86. Upon insertion of data tape cartridge 88 into one of drives 84, host computing device 74 can write data to, and read data from, the data tape cartridge.

Cartridge storage 82 may include a number of conventional data tape cartridges housing magnetic tape, as well as a number of data tape cartridges housing non-tape storage media. The non-tape storage media store data in accordance with the techniques described herein, and may take the form of a variety of storage media, such as disk-shaped magnetic storage media, solid-state storage media, optical storage media, magneto-optical storage media, and holographic storage media.

Regardless of the type of internal storage media, the data tape cartridges have housings conforming to standard dimensions and features to be easily engaged by automation unit 78. Because the data tape cartridges conform to standard dimensions, cartridges housing different types of media are mechanically indistinguishable by automation unit 78. In this manner, the mechanical interfaces between automation unit 78 need not be adapted or upgraded to support non-tape media.

Furthermore, the data tape cartridges housing non-tape storage media may be self-contained storage devices that include necessary electronics and control circuitry for accessing the storage media. For example, a data tape cartridge may have standard external dimensions and features of a data tape cartridge, but may house a disk drive including the disk-shaped storage medium as well as the disk drive controller and read/write circuitry.

Accordingly, drives 84 may include one or more conventional tape drives and one or more tape drive emulators for receiving data tape cartridges housing non-tape storage media. In other words, drives 84 may include one or more tape drive emulators such that the non-tape storage media appear to host computing device 74 as sequential storage devices. Specifically, the tape drive emulators communicate with host computing device 74 as conventional tape drives. For example, in response to a query from host computing device 74, the tape drive emulators may identify themselves as conventional tape drives, such as a standard 3480 tape drive. Consequently, the drivers and other software applications executing on host computing device 74 for accessing tape-based data tape cartridges need not be modified.

As with the data tape cartridges carrying non-tape media, the tape drive emulators may be physically configured for use with conventional backup infrastructure, such as library system 70. For example, the tape drive emulators may conform to standard dimensions and form factors of conventional tape drives that may readily be inserted within a drive bay of library system 70. The tape drive emulators may, for example, have appropriately located power connectors, mounting holes and electrical sockets for receiving data tape cartridges carrying non-tape media.

In this manner, data tape cartridges housing non-tape storage media physically appear the same as magnetic data tape cartridges from the perspective of automation unit 10, and functionally appears the same from the perspective of host computing device 74. Accordingly, a wide variety of storage media may be used within library automation system 2 with little or no change to automation unit 10 or host computing device 74. Although described in reference to library system 70, the principles of the invention are not limited to automated data tape cartridge systems. A system administrator or other user may, for example, manually insert the data tape cartridges into drives 84.

In addition, library system 70 can easily be migrated to larger storage capacities without upgrading drives 84. Unlike conventional systems in which the drives must be upgraded to support larger capacity magnetic data tape cartridges, the tape drive emulators can readily support non-data tape cartridges having increased storage capacities. For example, the tape drive emulators may readily detect the storage capacity of inserted data tape cartridges having non-tape storage media, possibly by querying the header stored by the media as described above, and report the storage capacity to host computing device 74. In this manner, library system 70 can be viewed as forward compatible with ensuing data tape cartridges having non-tape storage media of increased storage capacity.

Various embodiments of the invention have been described. Nevertheless, it is understood that various modification can be made without departing from the spirit and scope of the invention. These and other embodiments are within the scope of the following claims.

1. A method comprising:
receiving data in accordance with a tape drive communication protocol;
storing the data on a non-tape storage medium; and
updating a library of tape marks on the non-tape storage medium to identify locations within the stored data.

2. The method of claim 1, wherein the tape marks include at least one of a file mark, a sequential file mark, and a block mark.

3. The method of claim 1, wherein receiving data comprises receiving the data from a host computing device.

4. The method of claim 1, wherein storing the data comprises sequentially storing the data within a set of sequentially numbered logical storage areas of the non-tape storage medium.

5. The method of claim 4, wherein storing the data further comprises:
determining a current end of recorded data for the non-tape storage medium;
identifying one of the logical storage areas associated with the current end of recorded data;
writing the data to subsequent logical storage areas sequentially following the identified logical storage area; and
updating the current end of recorded data based on the logical storage areas storing the data.

6. The method of claim 4, wherein updating a library of tape marks comprises associating each of the tape marks with at least one of the logical areas.

7. The method of claim 4, wherein storing the data includes sequentially writing the data in increasing logical storage areas of the non-tape storage medium, and wherein updating a library of tape marks on the storage medium comprises sequentially writing the tape marks to the library for the stored data in decreasing logical storage areas.

8. The method of claim 1, further comprising:
receiving a command to write a tape mark to a tape, and
inserting a tape mark within the library in response to the command.

9. The method of claim 1, further comprising writing a header to the non-tape storage medium, wherein the header includes format identification data that marks the non-tape storage medium as emulating linear tape storage format.

10. The method of claim 9, further comprising writing a directory to the header to identify logical storage areas of the non-tape storage medium for a beginning of recorded data, a current end of recorded data, an end of available storage space, a beginning of the library of tape marks, and an end of the library of tape marks.

11. The method of claim 9, wherein the header specifies a type and a capacity of the non-tape storage medium.

12. The method of claim 9, wherein writing the header comprises writing the header to a first one of a set of sequentially numbered storage areas.

13. The method of claim 1, further comprising:
receiving an access command specifying advancement or rewinding of a tape medium via a number of tape marks;
accessing the library of tape marks in response to the command to identify a target location within the data; and
accessing the data stored on the non-tape storage medium based on the identified location.

14. The method of claim 1, further comprising:
receiving an access command via a tape drive communication protocol;
identifying a tape mark within the library of tape marks in response to the command;
identifying one of logical storage areas associated with the identified tape mark; and
accessing the data stored on the non-tape storage medium based on the identified tape mark.

15. The method of claim 1, wherein the non-tape storage medium comprises a disk-shaped storage medium.

16. The method of claim 1, further comprising:
caching the tape mark library in a memory of a computing device;
updating the cached tape mark library upon storing one or more of the data files on the non-tape storage medium; and
writing the cached tape mark library to the non-tape storage medium.

17. The method of claim 1, further comprising:
receiving a query from a host computing device in accordance with the tape drive communication protocol;
accessing a header stored on the non-tape storage medium to determine a capacity of the non-tape storage medium; and
communicating to the host computing device the capacity of the non-tape storage medium in accordance with the tape drive communication protocol so that the non-tape storage medium appears as a tape-based storage medium to the host computing device.

18. The method of claim 1, further comprising:
receiving the data from a tape drive emulator; and
storing the data on the non-tape storage medium within a data tape cartridge containing the non-tape storage medium.

19. A system comprising:
a data tape cartridge containing a non-tape storage medium having a set of logical storage areas; and
a tape drive emulator to receive the data tape cartridge and sequentially store data within the logical storage areas of the non-tape storage medium.

20. The system of claim 19, wherein the tape drive emulator maintains a library of tape marks on the storage medium to indicate locations within the stored data.

21. The system of claim 20, wherein the tape marks include at least one of a file mark, a sequential file mark, and a block mark.

22. The system of claim 20, wherein the non-tape storage medium stores a directory that identifies the logical storage areas for a current beginning of recorded data, a current end of recorded data, an end of available storage space, a beginning of the library of tape marks, and an end of the library of tape marks.

23. The system of claim 20, wherein the tape drive emulator receives an access command specifying advancement or rewinding of a tape medium via a number of tape marks, accesses the library of tape marks in response to the command to retrieve a target location within the data, and accesses the data stored based on the retrieved location.

24. The system of claim 20, wherein the tape drive emulator:
receives an access command via the tape drive communication protocol;
retrieves a tape mark from the library of tape marks in response to the command;
identifies one of the logical storage areas associated with the retrieved tape mark; and
accesses the data stored on the non-tape storage medium based on the retrieved tape mark.

25. The system of claim 20, wherein the tape drive emulator:
caches at least a portion of the tape mark library in a memory;
updates the cached tape mark library upon storing the data on the non-tape storage medium; and
writes the cached tape mark library to the non-tape storage medium.

26. The system of claim 19, wherein the tape drive emulator sequentially writes the data in increasing logical storage areas of the non-tape storage medium, and sequentially writes the tape marks to the library in decreasing logical storage areas of the non-tape storage medium.

27. The system of claim 19, wherein the non-tape storage medium stores a header having format identification data that marks the non-tape storage medium as emulating linear tape storage format.

28. The system of claim 27, wherein the header specifies a type and capacity of the non-tape storage medium.

29. The system of claim 19, wherein the tape drive emulator comprises a host interface to communicate with a host computing device via a tape drive communication protocol.

30. The system of claim 29, wherein the host interface conforms to one of the Small Computer System Interface (SCSI), the Fibre Channel interface, the Network Data Management Protocol (NDMP), and the Enhanced Integrated Drive Electronics/AT Attachment (EIDE/ATA) interface.

31. The system of claim 19, wherein the tape drive emulator comprises a translation unit to process tape drive commands and store the data on the non-tape storage medium in response to the tape drive commands.

32. The system of claim 31, wherein the library comprises one or more tape mark sectors, and each tape mark sectors include an array of tape mark locators for recording tape marks.

33. The system of claim 32, wherein the translation unit comprises a data buffer for buffering the data stream commands.

34. The system of claim 19, wherein the non-tape storage medium comprises a disk-shaped storage medium.

35. The system of claim 34, wherein the data tape cartridge includes a self-contained disk drive containing the disk-shaped storage medium and a disk driver controller.

36. The system of claim 34, wherein the data tape cartridge further comprises a disk drive controller to control access to the non-tape storage medium, wherein the controller communicates with the tape drive emulator according to one of the Small Computer System Interface (SCSI), the Fibre Channel interface, Serial ATA, and the Enhanced Integrated Drive Electronics/AT Attachment (EIDE/ATA) interface.

37. The system of claim 19, further comprising a host computing device coupled to the tape emulation unit, wherein the host drive emulator receives a query from the host computing device in accordance with the tape drive communication protocol, and accesses the header to determine the capacity of the non-tape storage medium.

38. The system of claim 19, wherein in response to a query from a host computing device the tape drive emulator identifies itself as an industry standard tape drive.

39. The system of claim 19, further comprising an automation unit to selectively retrieve the data tape cartridge from a plurality of data tape cartridges conforming to industry standard dimensions for magnetic data tape cartridges.

40. The system of claim 19, wherein the data tape cartridge comprises a housing conforming to industry standard dimensions for a magnetic tape drive cartridge.

41. A data tape cartridge comprising:
a data tape cartridge housing;
a non-tape storage medium within the data tape cartridge housing; and
format identification data stored by the non-tape storage medium that marks the non-tape storage medium as formatted to emulate linear tape storage.

42. The data tape cartridge of claim 41, wherein the non-tape storage medium is formatted to sequentially store data within a data region.

43. The data tape cartridge of claim 42, wherein the non-tape storage medium stores a library of tape marks on the storage medium to indicate locations within the stored data.

44. The data tape cartridge of claim 41, wherein the non-tape storage medium comprises a set of sequential logical storage areas.

45. The data tape cartridge of claim 43, wherein the library of tape marks comprises at least one of a block mark, a file mark, and a sequential file mark.

46. The data tape cartridge of claim 43, wherein the library of tape marks comprises one or more tape mark sectors, and each tape mark sector includes tape mark locators for recording the tape marks.

47. The data tape cartridge of claim 45, wherein the data is stored sequentially in increasing logical storage areas of the non-tape storage medium, and the tape marks are stored in decreasing logical storage areas.

48. The data tape cartridge of claim 45, wherein the non-tape storage medium stores a directory that identifies logical storage areas for a current beginning of recorded data, a current end of recorded data, an end of available storage space, a beginning of the library of tape marks, and an end of the library of tape marks.

49. The data tape cartridge of claim 41, wherein the housing conforms to industry standard dimensions for a magnetic data tape cartridge.

50. The data tape cartridge of claim 41, further comprising a controller to control access to the non-tape storage medium and to sequentially store the data within the logical storage areas of the non-tape storage medium.

51. The data tape cartridge of claim 50, wherein the non-tape storage medium comprises a disk-shaped storage medium and the controller comprises a disk drive controller.

52. The data tape cartridge of claim 51, wherein the data tape cartridge includes a self-contained disk drive housing the disk-shaped storage medium and the disk driver controller.

53. The data tape cartridge of claim 41, wherein the non-tape storage medium comprises one of a solid-state storage medium, an optical storage medium, a magneto-optical storage medium, and a holographic storage medium.

54. A non-tape storage medium having data comprising:
a header having format identification data that marks the non-tape storage medium as formatted to emulate linear tape storage;
a data region of sequentially stored data; and
a library of tape marks to indicate locations within the stored data in accordance with a tape drive communication protocol.

55. The non-tape storage medium of claim 54, wherein the non-tape storage medium includes sequentially numbered logical storage areas, and the tape marks associate each of the data with at least one of the logical areas.

56. The non-tape storage medium of claim 54, wherein the data region stores the data sequentially in increasing logical storage areas, and the library stores the tape marks in decreasing logical storage areas.

57. The non-tape storage medium of claim 54, wherein the header specifies a type and capacity of the non-tape storage medium.

58. The non-tape storage medium of claim 54, wherein the non-tape storage medium stores a directory that identifies the logical storage areas for a current beginning of recorded data, a current end of recorded data, an end of available storage space, a beginning of the library of tape marks, and an end of the library of tape marks.

59. The non-tape storage medium of claim 54, wherein the library comprises at least one of a file mark, a block mark, and a sequential file mark.

60. The non-tape storage medium of claim 54, wherein the non-tape storage medium comprises one of a solid-state storage medium, an optical storage medium, a magneto-optical storage medium, and a holographic storage medium.

61. A tape drive emulator comprising a controller to sequentially store data on a non-tape storage medium in accordance with a format that emulates a tape storage format, wherein the controller maintains a library of tape marks on the storage medium to indicate locations within the data in accordance with a tape drive communication protocol.

62. The tape drive emulator of claim 61, wherein the controller sequentially stores data within logical storage areas of the non-tape storage medium.

63. The tape drive emulator of claim 62, wherein each of the tape marks specifies one of the logical storage areas.

64. The tape drive emulator of claim 62, wherein the non-tape storage medium stores a directory that identifies the logical storage areas for a current beginning of recorded data, a current end of recorded data, an end of available storage space, a beginning of the library of tape marks, and an end of the library of the tape marks.

65. The tape drive emulator of claim 63, wherein the tape drive emulator receives an access command specifying advancement or rewinding of a tape medium via a number of tape marks, accesses the library of tape marks in response to the command to retrieve a target location within the data in response to the command, and accesses the data stored on the non-tape storage medium based on the retrieved target location.

66. The tape drive emulator of claim 63, wherein the tape drive emulator:
receives an access command via the tape drive communication protocol;
retrieves a tape mark from the library of tape marks in response to the command;
identifies one of the logical storage areas associated with the retrieved tape mark; and
accesses the data stored on the non-tape storage medium based on the retrieved tape mark.

67. The tape drive emulator of claim 61, further comprising an electrical socket to receive an electrical connector of a data tape cartridge carrying a non-tape storage medium.

68. The tape drive emulator of claim 67, wherein the socket includes a mechanical actuation mechanism operable by a data tape cartridge library automation system to electrically couple the data tape cartridge to the emulation tape drive.

69. The tape drive emulator of claim 61, wherein the tape drive emulator comprises a host interface to electrically couple the tape drive emulator to a host computing device.

70. The tape drive emulator of claim 61, wherein the non-tape storage medium comprises a disk-shaped storage medium and the controller within the tape drive emulator comprises a disk drive controller.

71. The tape drive emulator of claim 61, wherein the tape drive emulator has a form factor of an industry standard tape drive such that the location of the socket conforms to the location of a slot within the industry standard tape drive.
